(19) United States
(12) Patent Application Publication
(10) Pub. No.: US 2025/0224547 A1
(43) Pub. Date: Jul. 10, 2025

(54) LIGHT GUIDE MEMBER COMPRISING DIFFRACTION PATTERN

(71) Applicant: LG INNOTEK CO., LTD., Seoul (KR)

(72) Inventors: Bum Jin KIM, Seoul (KR); Kyu Tae LEE, Seoul (KR)

(21) Appl. No.: 18/879,573

(22) PCT Filed: Jun. 26, 2023
(86) PCT No.: PCT/KR2023/008852

§ 371 Date: Dec. 27, 2024

(30) Foreign Application Priority Data
Jun. 29, 2022 (KR) 10-2022-0079909

(51) Int. Cl. G02B 5/18; G02B 27/01; G02B 27/42

(52) U.S. Cl. CPC G02B 5/1842; G02B 27/4266; G02B 27/0172; G02B 2027/0178

(57) ABSTRACT

A light guide member according to an embodiment comprises at least one light guide from among a first light guide, a second light guide and a third light guide, wherein each of the first light guide, the second light guide and the third light guide includes a structure that reacts to light of different wavelength ranges, the first light guide includes a first substrate and a first structure, which is arranged on the first substrate and reacts to light of a first wavelength range, the first wavelength is 380 nm to 500 nm, the first structure is formed from an aggregate of a plurality of first unit structures, the structure of the first unit structures includes a first protrusion, the first protrusion protrudes in a first direction, and the first protrusion is symmetrical with respect to a second direction by having, as the axis thereof, the first direction line, which passes through the center of the first unit structure.

### TECHNICAL FIELD

The embodiment relates to a light guide member including a diffraction pattern.

### BACKGROUND ART

With the advancement in technology, various types of wearable devices that can be worn on the body are released recently. Among them, the augmented reality (AR) device is a wearable device in the form of glasses worn on the head of a user. The AR device provides visual information through a display. Accordingly, the user may receive AR services.

Augmented reality is a technique that mixes real-world information with virtual images by inserting three-dimensional images in a real environment.

Real-world information may contain information that a user does not need. Or, real-world information may lack information that a user needs. However, an augmented reality system combines a real world and a virtual world. Accordingly, interactions between the real world and the virtual world take place in real time.

Unlike a virtual reality (VR) device that blocks the field of vision, an augmented reality (AR) device does not block the field of vision while being in use. In addition, the AR device shows a wide screen-level display in front of a user while being worn on like regular glasses. In addition, the AR device may provide an extended reality that combines reality and AR contents by utilizing a 360° space from the viewpoint of a user. In addition, the AR device may provide a display optimized for a user while both hands are free.

The augmented reality device includes an optical module. The optical module provides augmented reality images to users. For example, the augmented reality device is configured as wearable glasses. In addition, a projector that projects images onto the wearable glasses may be combined.

Light emitted from the projector passes through a wave guide or AR glasses and enters the eyes of a user. Accordingly, the user may perceive an augmented reality display.

Meanwhile, light emitted from the projector is diffracted by the waveguide or AR glasses. Then, the diffracted light may enter the eyes of a user. Therefore, the waveguide or the AR glasses may include a diffraction pattern. The diffraction pattern may react in a specific wavelength region. However, since the diffraction efficiency is not uniform at all angles, optical efficiency of the augmented reality device may be lowered.

Accordingly, a waveguide or AR glasses having uniform and high efficiency in the entire angular range, while having a bandwidth of wide angle, is required.

### DISCLOSURE

### Technical Problem

The embodiment provides a diffraction pattern that allows light of different wavelengths to have uniform efficiency at a wide incident angle. In addition, a light guide member including the diffraction pattern is provided.

### Technical Solution

A light guide member according to an embodiment comprises: at least one light guide among a first light guide, a second light guide and a third light guide, wherein each of the first light guide, the second light guide, and the third light guide includes a structure that reacts to light of a different wavelength range, the first light guide includes a first substrate and a first structure arranged on the first substrate to react to light of a first wavelength range, the first wavelength is 380 nm to 500 nm, the first structure is formed as an aggregate of a plurality of first unit structures, a structure of the first unit structures includes a first protrusion, the first protrusion protrudes in a first direction, and the first protrusion is symmetrical in a second direction with respect to a line of a first direction passing through a center of the first unit structure.

### Advantageous Effects

The light guide member according to an embodiment includes a plurality of light guides.

Each of the plurality of light guides includes a structure that reacts to light of a specific wavelength band.

Therefore, each of the plurality of light guides diffracts light of a specific wavelength band.

The shape of the structure may be controlled. In addition, the thickness of the structure may be controlled. In addition, the size of the unit structure of the structure may be controlled.

Therefore, light of different wavelengths may be diffracted by different structures, respectively. In addition, each light guide may include a structure different in the shape and size to have optimal diffraction efficiency according to the wavelength of incident light.

Therefore, the light guide member according to an embodiment may have uniform and high diffraction efficiency within a range of wide incident angle.

### DESCRIPTION OF DRAWINGS

FIG. 1 is a view for explaining flow of light passing through a light guide member according to an embodiment.

FIG. 2 is a top view showing a light guide included in a light guide member according to an embodiment.

FIG. 3 is a cross-sectional view taken along section A-A′ in FIG. 2.

FIGS. 4 to 8 are top views showing any one light guide among light guides according to an embodiment.

FIGS. 9 to 13 are graphs for explaining the diffraction angle and diffraction efficiency of any one light guide among light guides according to an embodiment.

FIGS. 14 to 18 are top views showing another light guide among light guides according to an embodiment.

FIGS. 19 to 23 are graphs for explaining the diffraction angle and diffraction efficiency of another light guide among light guides according to an embodiment.

FIG. 24 is view showing a wearable device to which a light guide member according to an embodiment is applied.

### MODE FOR INVENTION

Hereinafter, preferred embodiments of the present invention will be described in detail with reference to the attached drawings.

However, the technical spirit of the present invention is not limited to some of the described embodiments, but may be implemented in various different forms, and one or more of the components may be selectively combined or replaced among the embodiments without departing from the scope of the technical spirit of the present invention. In addition, unless explicitly and specifically defined and described, terms (including technical and scientific terms) used in the embodiments of the present invention may be interpreted as a meaning that can be generally understood by those skilled in the art, and commonly used terms, such as terms defined in a dictionary, may be interpreted considering the contextual meaning of related techniques. In addition, the terms used in the embodiments of the present invention are for describing the embodiments and are not intended to limit the present invention. In this specification, singular forms may also include plural forms unless specifically stated in the phrase, and when it is described as “at least one (or more) among A, B, and C,” it may include one or more of all combinations that can be combined using A, B, and C. In addition, in describing the components of the embodiments of the present invention, terms such as first, second, A, B, (a), and (b) may be used. These terms are used only to distinguish one component from other components, and the nature, sequence, or order of the components are not limited by the terms. In addition, when a component is described as being ‘connected’, ‘coupled’, or ‘combined’ to another component, it may also include the cases where the component is ‘connected’, ‘coupled’, or ‘combined’ by still another component arranged between the component and another component, as well as the cases where the component is directly coupled, connected, or combined to another component.

In addition, when it is described as being formed or arranged “on (above)” or “under (below)” each component, it may also include the cases where one or more other components are formed or arranged between two components, as well as the cases where two components are directly in contact with each other. In addition, when it is expressed as “on (above) or under (below)”, it may also include the downward direction, as well as the upward direction, from the aspect of one component.

Meanwhile, a first direction and a second direction described below may be the X-axis direction (left-right direction) or the Y-axis direction (up-down direction), respectively. For example, the first direction may be the X-axis direction, and the second direction may be the Y-axis direction. Alternatively, the first direction may be the Y-axis direction, and the second direction may be the X-axis direction.

Hereinafter, a light guide member according to an embodiment will be described with reference to the drawings.

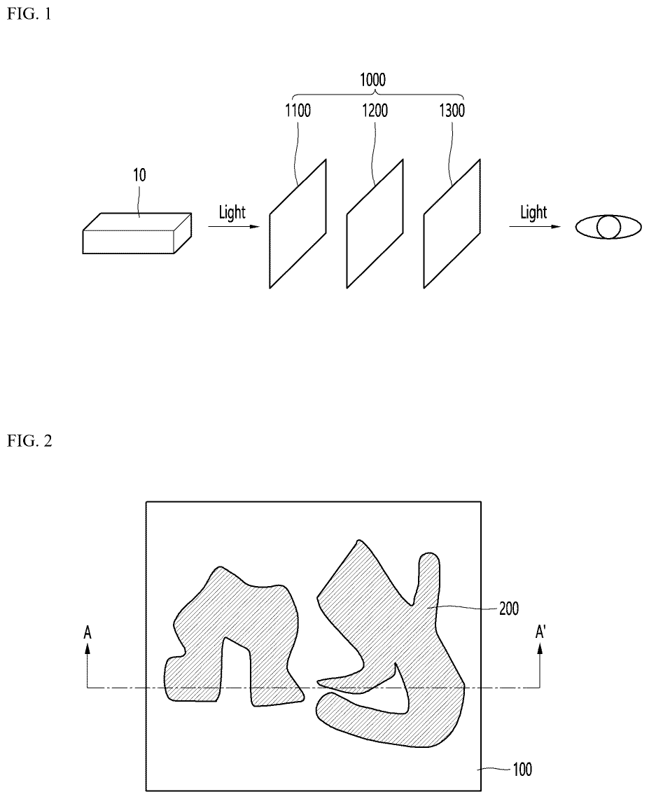

FIG. 1 is a view for explaining flow of light (ray) passing through a light guide member according to an embodiment.

Referring to FIG. 1, a light source 10 emits light (ray). For example, the light source 10 may emit laser light. The light passes through a light guide member 1000 and enters the eyes of a user. The light source 10 may include a projector.

The light source 10 may emit light of different colors. Specifically, the light source 10 may emit light of different wavelengths. For example, the light source 10 may emit first light, second light, and third light. Specifically, the light source 10 may emit a first light of red light (R), a second light of blue light (B), and a third light of green light (G).

The light guide member 1000 may include a plurality of light guides. For example, the light guide member 1000 may include a first light guide 1100, a second light guide 1200, and a third light guide 1300.

The first light guide 1100 may include a first diffraction pattern. The second light guide 1200 may include a second diffraction pattern. The third light guide 1300 may include a third diffraction pattern.

The first diffraction pattern, the second diffraction pattern, and the third diffraction pattern may react only in a specific wavelength region. That is, the first diffraction pattern, the second diffraction pattern, and the third diffraction pattern may have wavelength-selective characteristics. Accordingly, the first light, the second light, and the third light may be diffracted in at least one among the first light guide 1100, the second light guide 1200, and the third light guide 1300.

For example, the first light may be diffracted in the first light guide 1100. The second light may be diffracted in the second light guide 1200. The third light may be diffracted in the third light guide 1300. That is, the first light, the second light, and the third light may be diffracted in different light guides.

However, the embodiment is not limited thereto. In FIG. 1, it is shown that the light guide member 1000 includes the first to third light guides. However, the light guide member 1000 may omit at least one light guide. For example, the light guide member 1000 may include the first light guide 1100 and the second light guide 1200. That is, the third light guide 1300 may be omitted.

Accordingly, the third light may be diffracted in at least one among the first light guide 1100 and the second light guide 1200.

The light guide member may be at least one among a wave guide or AR glasses. That is, light emitted from the light source 10 passes through the wave guide, which is a light guide member, and enters the AR glasses. Accordingly, the user may perceive a display. Alternatively, light emitted from the light source 10 enters the AR glasses, which is a light guide member. Accordingly, the user may perceive a display.

Meanwhile, when the light guide member diffracts light having a wide incident angle, the user's visibility may be improved. In addition, the light guide member should have uniform and high diffraction efficiency within the range of incident angle.

Hereinafter, a light guide member having uniform and high diffraction efficiency within the range of incident angle, while having a bandwidth of wide incident angle, will be described.

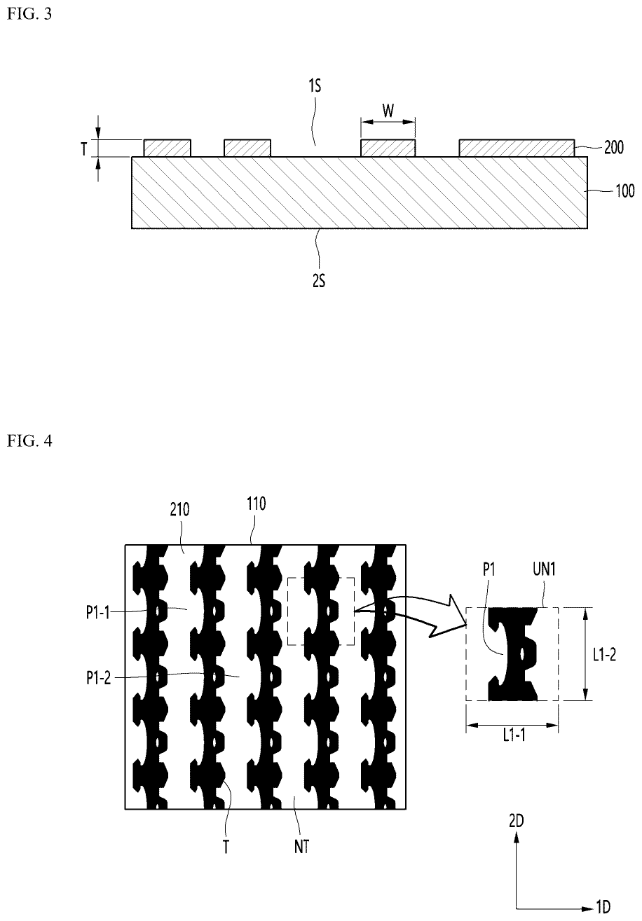

FIGS. 2 and 3 are views for explaining a light guide of a light guide member according to an embodiment. FIGS. 2 and 3 are views for explaining the configuration of a light guide member. The specific shape of the light guide is described below in detail.

Referring to FIGS. 2 and 3, the light guide may include a substrate 100 and a structure 200.

The substrate 100 may include a material that may transmit light. For example, the substrate 100 may include glass or plastic. For example, the substrate 100 may include polyethylene terephthalate (PET) or polyimide (PI).

The substrate 100 may support the structure 200. The substrate 100 may be a wave guide or AR glasses.

The substrate 100 may include a first surface 1S and a second surface 2S opposite to the first surface 1S. The first surface 1S and the second surface 2S may be defined by the distance from the eyes of a user. For example, the first surface 1S may be far from the eyes of a user. In addition, the second surface 2S may be close to the eyes of a user. For example, when the substrate 100 is AR glasses, the first surface 1S may be the outer surface of the AR glasses. In addition, the second surface 2S may be the inner surface of the AR glasses.

The structure 200 may be arranged on the substrate 100. The structure 200 may be arranged on at least one among the first surface 1S and the second surface 2S of the substrate 100. For example, the structure 200 may be arranged on the first surface 1S. Alternatively, the structure 200 may be arranged on the second surface 2S. Alternatively, the structure 200 may be arranged on the first surface 1S and the second surface 2S.

The structure 200 may include a material that is the same as or similar to that of the substrate 100. Alternatively, the structure 200 may include a material different from that of the substrate 100. For example, the structure 200 may include TiOx, HfOx, SiOx, Si, GaAs, or Ge.

The structure 200 may be a diffraction pattern. Light passing through the light guide may be diffracted by the structure 200. The structure 200 may include a plurality of patterns. Specifically, the structure 200 may include a plurality of patterns spaced apart from each other. The structure 200 may be formed as a meta surface of a freeform shape. Accordingly, the light guide may diffract light of a specific wavelength region at a diffraction angle of a set range.

The structure 200 may have a width W and a thickness T of a set range. For example, the structure 200 may have a thickness of a set range. For example, the structure 200 may have a similar thickness in the entire area of the substrate 100. In addition, the structure 200 may have a width of a set range. For example, the structure 200 may have a different width in the entire area of the substrate 100. That is, the width of the structure 200 arranged in one area of the substrate 100 and the width of the structure 200 arranged in another area may be different. Accordingly, the structure 200 may have a similar thickness and a different width in the entire area of the substrate 100.

Additionally, the substrate 100 and the structure 200 may have a refractive index of a set range.

For example, the substrate 100 and the structure 200 may have a refractive index of 1.5 to 4. The substrate 100 and the structure 200 may have the same or different refractive indices within the refractive index range. For example, the refractive index of the structure 200 may be higher than the refractive index of the substrate 100.

Meanwhile, the diffraction efficiency of the light guide may be determined by the intensity of light traveling in the direction of diffraction angle in contrast to the intensity of incident light. In addition, the intensity of light passing through the light guide may be determined by the transmittance and the phase change after transmission, which are results of the interaction between the incident light and the structure.

That is, the intensity of light traveling in the direction of diffraction angle may vary according to the shape and size of the structure.

The light guide member according to an embodiment arranges the structure in a shape having an optimal diffraction efficiency according to the wavelength of light entering the light guide. Accordingly, light passing through the light guide member may have uniform and high diffraction efficiency within a range of wide incident angle.

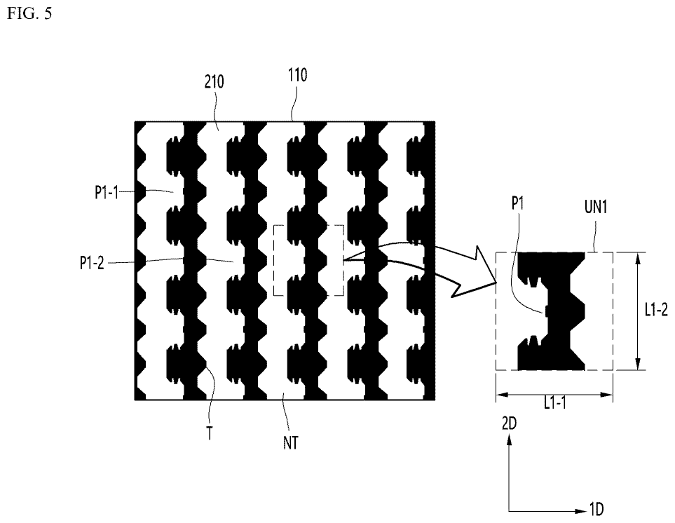

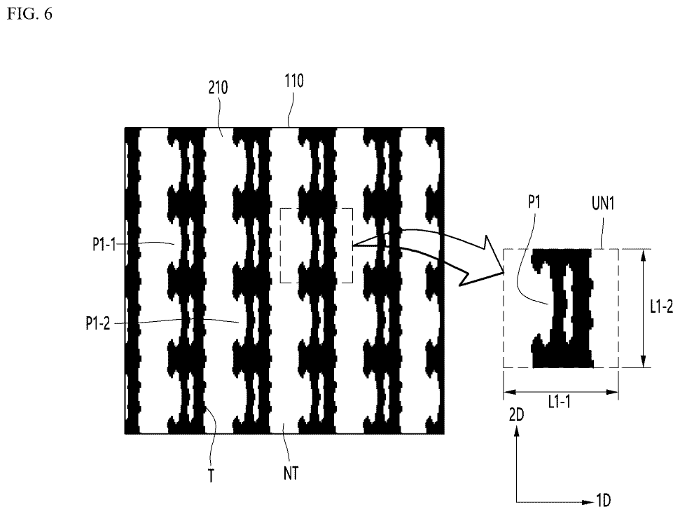

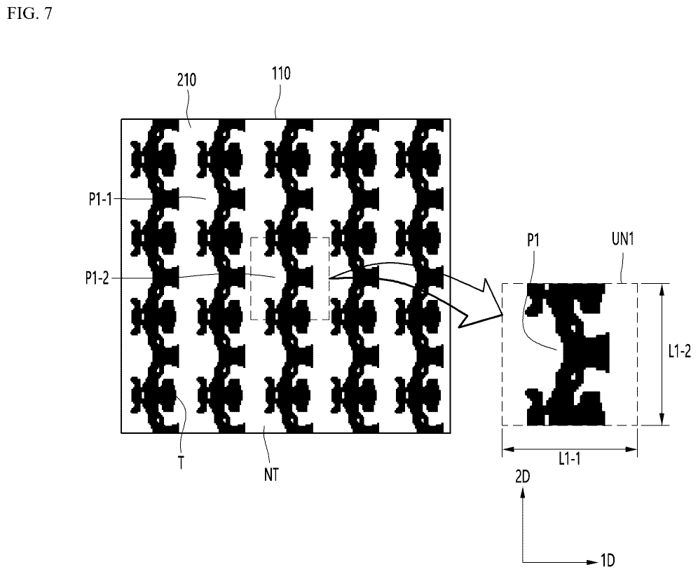

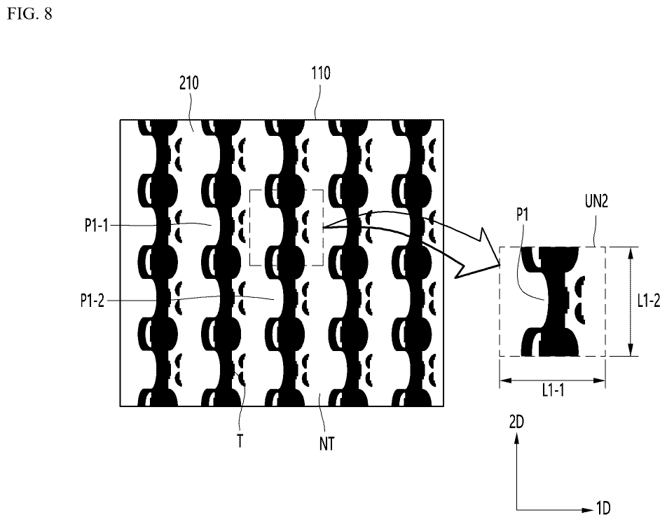

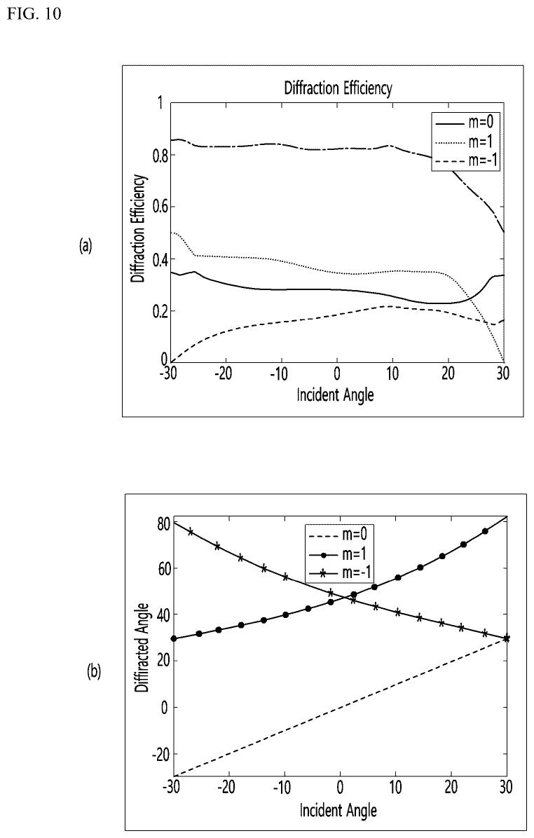

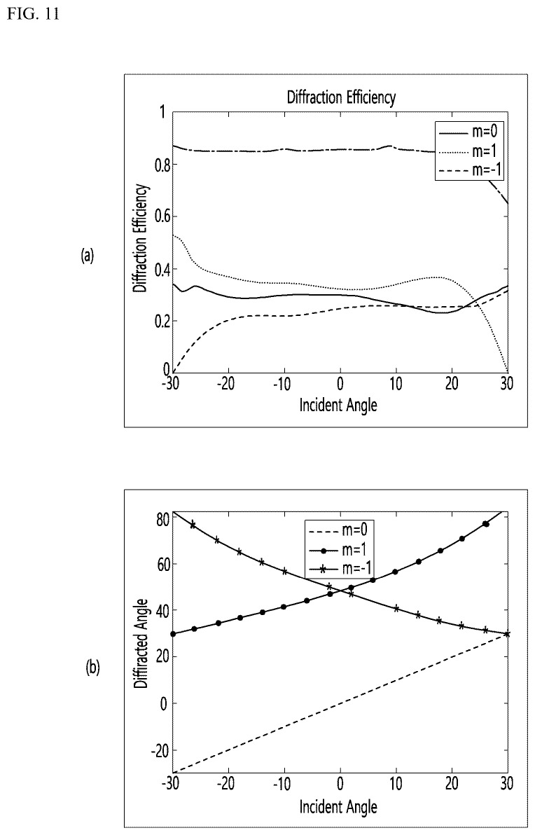

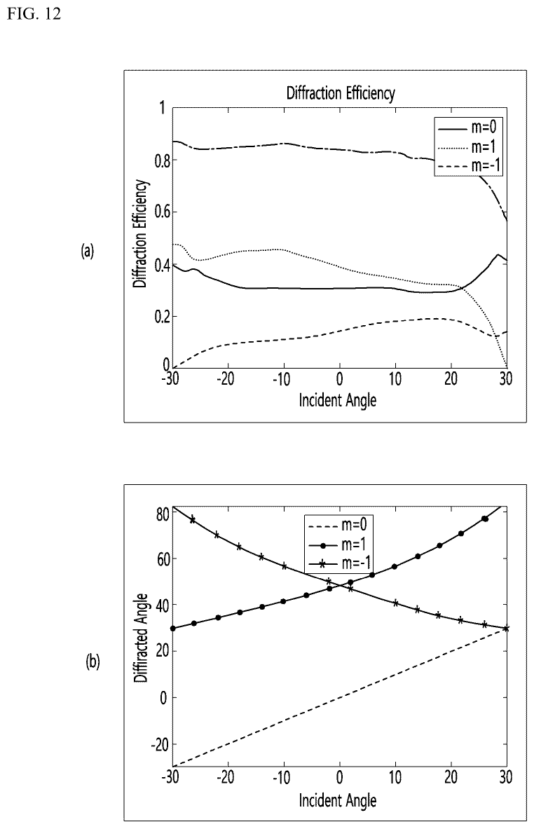

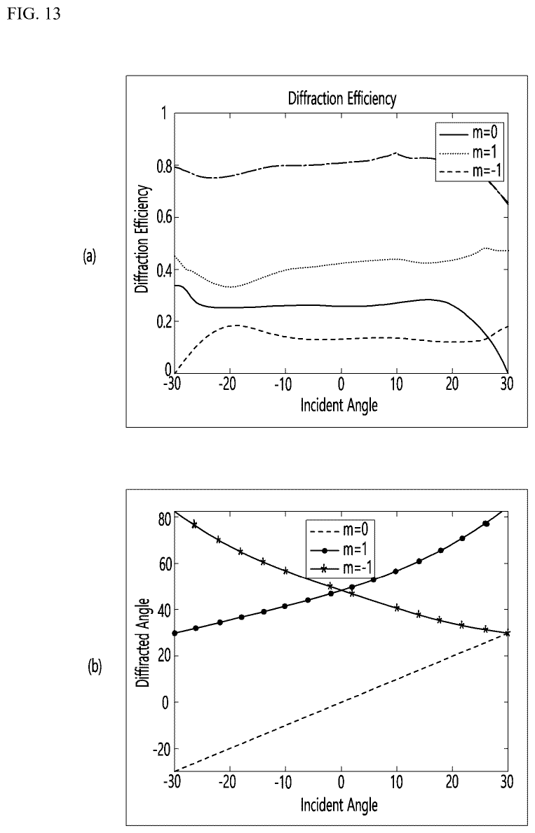

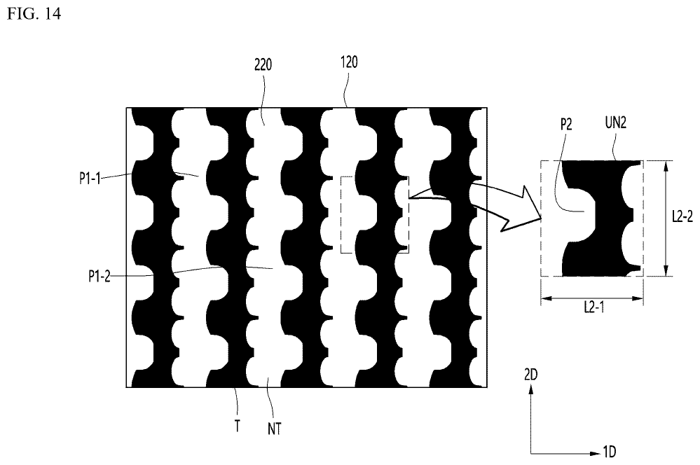

Hereinafter, the structure of the first light guide will be described with reference to FIGS. 4 to 13.

Referring to FIGS. 4 to 8, the first light guide 1100 may include a first structure 210.

FIGS. 4 to 8 are top views showing the first light guide 1100. Referring to FIGS. 4 to 8, the first light guide 1100 may include a first substrate 110 and a first structure 210.

The first structure 210 may diffract light in a wavelength band of a set range. Specifically, the first structure 210 may selectively diffract light in at least one wavelength band among red light and green light. That is, the first structure 210 may selectively diffract light in a first wavelength band of red light. Alternatively, the first structure 210 may selectively diffract light in a third wavelength band of green light. Alternatively, the first structure 210 may selectively diffract light in the first wavelength band of red light or light in the third wavelength band of green light.

Hereinafter, for convenience of explanation, it will be described focusing on the case where the first structure 210 selectively diffracts light in the first wavelength band of red light.

The first substrate 110 may include a first transmission region T and a second transmission region NT defined by the first structure 210. Specifically, the first substrate 110 may include a first transmission region T where the first structure 210 is not arranged and a second transmission region NT where the first structure 210 is arranged. Light passing through the first light guide 1100 may be diffracted by the first transmission region T and the second transmission region NT. Specifically, a phase difference occurs between the light passing through the first transmission region T and the light passing through the second transmission region NT. In addition, the sum of the phase differences may appear as a diffraction phenomenon.

The first structure 210 may include a plurality of patterns. For example, the first structure 210 may include a 1-1 pattern P1-1 and a 1-2 pattern P1-2. The 1-1 pattern P1-1 and the 1-2 pattern P1-2 may be extended in the second direction 2D. That is, the 1-1 pattern P1-1 and the 1-2 pattern P1-2 may have a width in the first direction 1D and a length in the second direction 2D. In addition, the 1-1 pattern P1-1 and the 1-2 pattern P1-2 may be spaced apart from each other. Specifically, the 1-1 pattern P1-1 and the 1-2 pattern P1-2 may be spaced apart in the first direction 1D.

The first structure 210 may include a plurality of unit structures. For example, the first structure 210 may include a plurality of first unit structures UN1. When the first substrate 110 is divided into a plurality of unit areas, a structure in which structure shapes of the same shape are arranged in a plurality of unit areas may be defined as the first unit structure UN1.

Accordingly, the first unit structures UN1 adjacent in the first direction 1D may include the first structures 210 of the same shape. For example, one of the first unit structures UN1 adjacent in the first direction 1D may be the 1-1 pattern P1-1. In addition, another first unit structure may be the 1-2 pattern P1-2.

In addition, the first unit structures UN1 adjacent in the second direction 2D may include the first structures 210 of the same shape. For example, all the first unit structures UN1 adjacent in the second direction 2D may be the 1-1 pattern P1-1 or the 1-2 pattern P1-2.

In addition, the first unit structures UN1 adjacent in a diagonal direction of the first direction 1D and the second direction 2D may include the first structures 210 of the same shape. For example, any one first unit structure among the first unit structures UN1 adjacent in a diagonal direction may be the 1-1 pattern P1-1. In addition, another first unit structure may be the 1-2 pattern P1-2.

That is, the first light guide may be an aggregate of a plurality of first unit structures UN1.

The first unit structure UN1 may include structures symmetrical to each other. For example, the first structure 210 of the first unit structure UN1 may be symmetrical in the second direction 2D. That is, the first structure 210 of the first unit structure UN1 may be symmetrical in the second direction 2D with respect to the first direction 1D.

Accordingly, the first transmission region T and the second transmission region NT of the first unit structure UN1 may be symmetrical in the second direction 2D.

However, the embodiment is not limited thereto, and the first structure 210 of the first unit structure UN1 may be symmetrical in the first direction 1D. That is, the first structure 210 of the first unit structure UN1 may be symmetrical in the first direction 1D with respect to the second direction 2D.

Alternatively, the first structure 210 of the first unit structure UN1 may be symmetrical in the diagonal direction of the first direction 1D and the second direction 2D.

Hereinafter, for convenience of explanation, it will be described focusing on the case where the first structure 210 of the first unit structure UN1 is symmetrical in the second direction 2D with respect to the first direction 1D.

The first structure 210 may have a thickness of a set range. Specifically, the thickness of the first structure 210 may be related to the wavelength size of light reacting with the first structure 210.

The thickness of the first structure 210 may be smaller than the wavelength of light reacting with the first structure. Specifically, the thickness of the first structure 210 may satisfy equation 1 shown below.

First wavelength*0.25≤Thickness of first structure<First wavelength*0.75 [Equation 1]

(Here, the first wavelength is 380 nm to 500 nm)

When the thickness of the first structure 210 satisfies equation 1, the interaction between the light (ray) entering at a set angle and the first structure increases. Accordingly, the diffraction efficiency can be improved.

However, when the thickness of the first structure 210 is smaller than 0.25 of the first wavelength, the interaction between the light (ray) entering at a set angle and the first structure decreases. Accordingly, the diffraction efficiency may be lowered. In addition, when the thickness of the first structure 210 is more than 0.75 of the first wavelength, the change in the diffraction efficiency of the light (ray) entering at different angles may increase. Accordingly, the diffraction efficiency in a range of wide incident angle may be low. Or, the diffraction efficiency in a range of wide incident angle may be non-uniform.

The first unit structure UN1 may have a size of a set range. Specifically, the first unit structure UN1 has a length in the first direction L1-1 and a length in the second direction L1-2. The length in the first direction L1-1 and the length in the second direction L1-2 may have a set range.

The length in the first direction L1 and the length in the second direction L2 may be the same. That is, the first unit structure UN1 may be formed in a square shape.

Alternatively, the length in the first direction L1-1 and the length in the second direction L1-2 may be different. For example, the length in the first direction L1-1 may be greater than the length in the second direction L1-2. Alternatively, the length in the first direction L1-1 may be smaller than the length in the second direction L1-2. That is, the first unit structure UN1 may be formed in a rectangular shape.

The length in the first direction L1-1 and the length in the second direction L1-2 may be related to the wavelength size of light reacting with the first structure 210.

At least one length among the length in the first direction L1-1 and the length in the second direction L1-2 may be smaller than the wavelength of light reacting with the first structure. Specifically, the length in the first direction L1-1 and the length in the second direction L1-2 may satisfy equation 2 shown below.

First wavelength*0.5≤Length in the first direction L1-1<First wavelength*0.75,

or

First wavelength*0.5≤Length in the second direction L1-2<First wavelength*0.75,

or

First wavelength*0.5≤Length in the first and second directions L1-1 and L1-2<first wavelength*0.75. [Equation 2]

(Here, the first wavelength is 380 nm to 500 nm)

When the length in the first direction L1-1 and the length in the second direction L1-2 satisfy equation 2, the interaction between the light (ray) entering at a set angle and the first structure increases. Accordingly, the diffraction efficiency can be improved.

However, when the length in the first direction L1-1 and the length in the second direction L1-2 do not satisfy equation 2, the interaction between the light (ray) entering at a set angle and the first structure decreases. Accordingly, the diffraction efficiency may be lowered.

Alternatively, the length in the first direction L1-1 and the length in the second direction L1-2 may be related to the thickness of the first structure 210.

At least one length among the length in the first direction L1-1 and the length in the second direction L1-2 may be greater than the thickness of the first structure 210. Specifically, the length in the first direction L1-1 and the length in the second direction L1-2 may satisfy equation 3 shown below.

Length in the first direction L1-1*0.25≤Thickness of first structure≤Length in the first direction L1-1*0.75, or

Length in the second direction L1-2*0.25≤Thickness of first structure≤Length in the second direction L1-2*0.75, or

Length in the first and second directions L1-1 and L1-2*0.25≤Thickness of first structure≤Length in the first and second directions L1-1 and L1-2*0.75. [Equation 3]

When the thickness of the first structure satisfies equation 3, the interaction between the light (ray) entering at a set angle and the first structure increases. Accordingly, the diffraction efficiency can be improved.

However, when the thickness of the first structure does not satisfy equation 3, the interaction between the light (ray) entering at a set angle and the first structure decreases. Accordingly, the diffraction efficiency may be lowered.

The first unit structure UN1 may include a first protrusion unit P1. The first protrusion unit P1 may protrude in one direction. Specifically, the first protrusion unit P1 may protrude in the first direction D1. The first protrusion unit P1 may include a curved surface. The first protrusion unit P1 may be formed in a shape of which the width is narrowed while being extended in the protruding direction. Accordingly, the width of the first structure 210 of the first unit structure UN1 may decrease while being extended in the direction of the first protrusion unit P1.

In addition, the first protrusion unit P1 may be symmetrical in the second direction D2. That is, the first protrusion unit P1 may be symmetrical in the second direction D2 with respect to the line of the first direction passing through the center of the first unit structure UN1. That is, the first protrusion unit P1 may be symmetrical in the second direction 2D while protruding in the first direction D1.

The first structure 210 of the first unit structure UN1 may be arranged to have an area of a set range. For example, the area of the first structure 210 may be 50% or more of the total area of the first unit structure UN1. Specifically, the area of the first structure 210 may be 55% or more of the total area of the first unit structure UN1. More specifically, the area of the first structure 210 may be 60% or more of the total area of the first unit structure UN1.

In addition, the first structure 210 of the first unit structure UN1 may have a maximum pattern line of a set range. The maximum pattern line of the first structure 210 may be defined as a line having the largest number of pixels among the lines of the first direction 1D when the first unit structure UN1 is divided into a plurality of pixels.

The maximum pattern line of the first structure 210 may be 30 pixels or more. Specifically, the maximum pattern line of the first structure 210 may be 35 pixels or more.

In addition, the first structure 210 of the first unit structure UN1 may have a maximum pattern ratio of a set range. The maximum pattern ratio of the first structure 210 may be defined as a ratio of the length of the maximum pattern line to the total length of the line having the maximum pattern line.

The maximum pattern ratio of the first structure 210 may be 70% or higher. Specifically, the maximum pattern ratio of the first structure 210 may be 75% or higher. In more detail, the maximum pattern ratio of the first structure 210 may be 80% or higher.

When the first structure 210 satisfies the ranges of the area, maximum pattern line, and maximum pattern ratio, the interaction between the light (ray) entering at a set angle and the first structure increases. Accordingly, the diffraction efficiency can be improved.

However, when the first structure 210 does not satisfy the ranges of the area, maximum pattern line, and maximum pattern ratio, the interaction between the light (ray) entering at a set angle and the first structure decreases. Accordingly, the diffraction efficiency may be lowered. In addition, the ratio of the first structure 210 increases. Accordingly, as the pattern of the first structure 210 may be perceived from the outside, the visibility may be lowered.

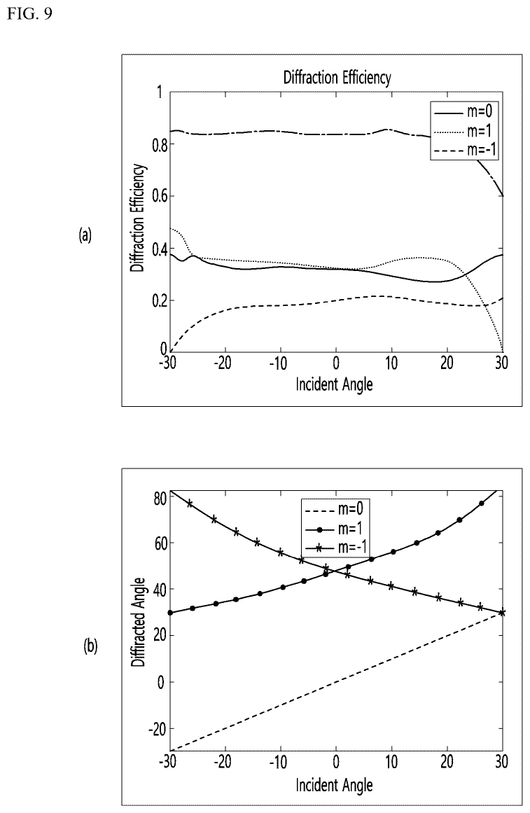

FIGS. 9 to 13 are views for explaining diffraction efficiency of the first light guide having the first unit structure of FIGS. 4 to 8, respectively.

FIGS. 9 to 13 (a) are graphs showing diffraction efficiency according to the incident angle. m=0 means light transmitted (refracted) without diffraction. m=1 means diffracted light. m=−1 means light that may generate various side effects due to the environment although diffraction is not targeted.

FIGS. 9 to 13 (b) are graphs showing diffraction angles according to the incident angle. m=−1 means an angle at which-1st-order diffracted light travels. m=0 means an angle at which 0th-order diffracted light travels. m=1 means an angle at which 1st-order diffracted light travels.

Referring to FIGS. 9 to 13, it can be seen that the diffracted m=1 curve has a uniform and high diffraction efficiency in a range of −23° to 23°.

In addition, lines other than m=−1, m=0, and m=1 mean a sum of diffraction efficiencies of the-1st, 0th, and 1st orders. In other words, it means that there are efficiencies of higher-order terms other than the-1st, 0th, and 1st orders. Referring to FIGS. 9 to 13, it can be seen that there is an efficiency of higher-order terms of about 20% or less in a range of −23° to 23°.

That is, it can be seen that the first light guide including the first structure according to an embodiment has uniform and high diffraction efficiency in a bandwidth range of wide incidence angle.

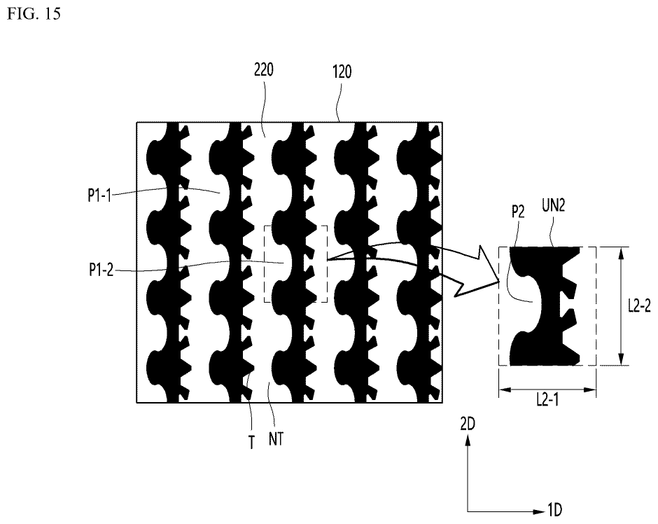

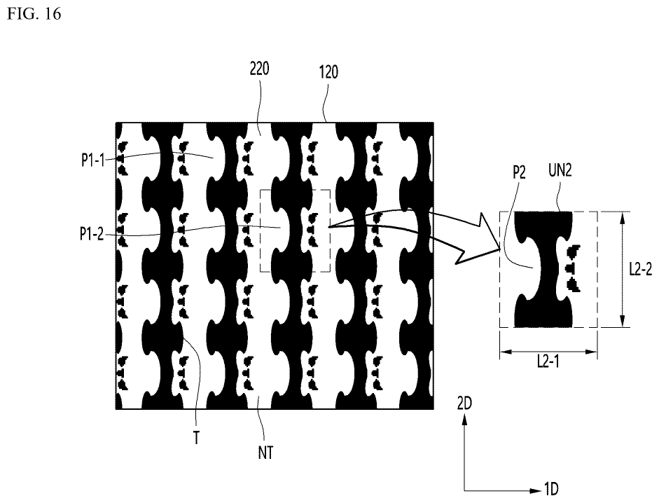

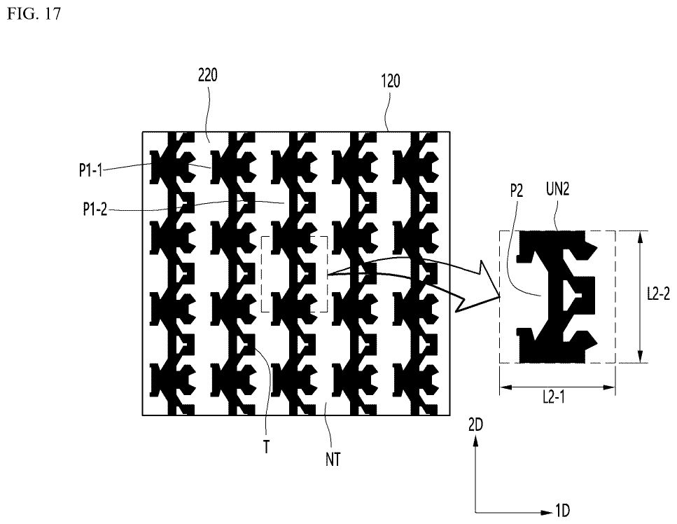

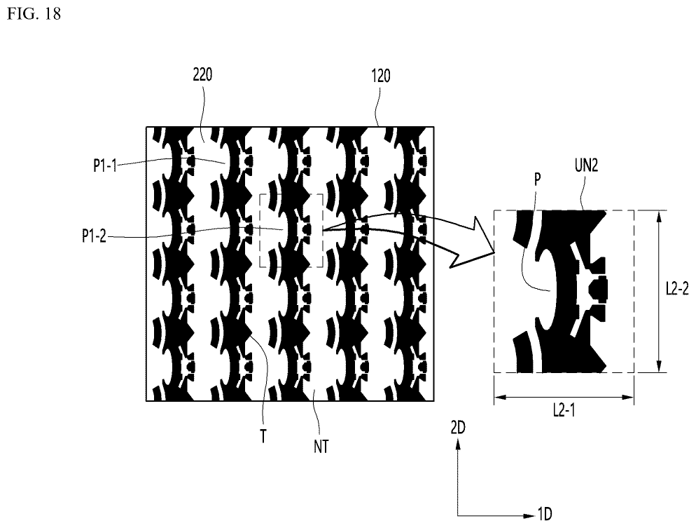

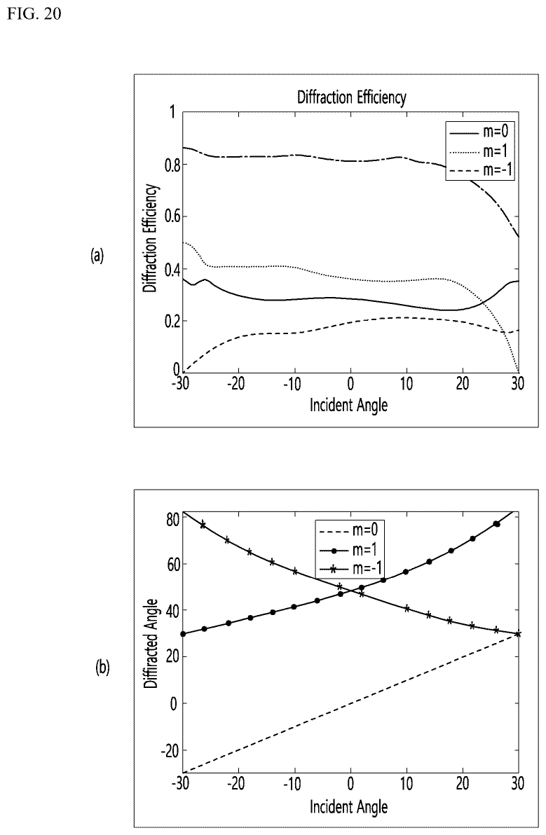

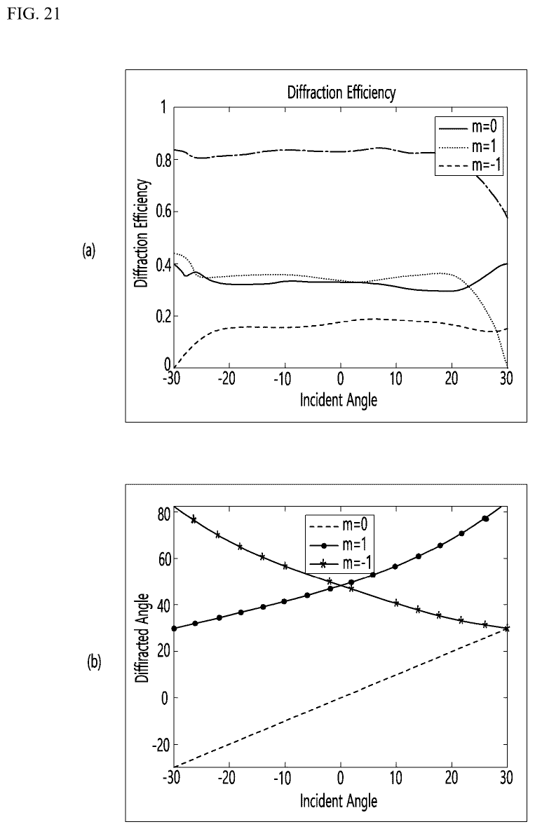

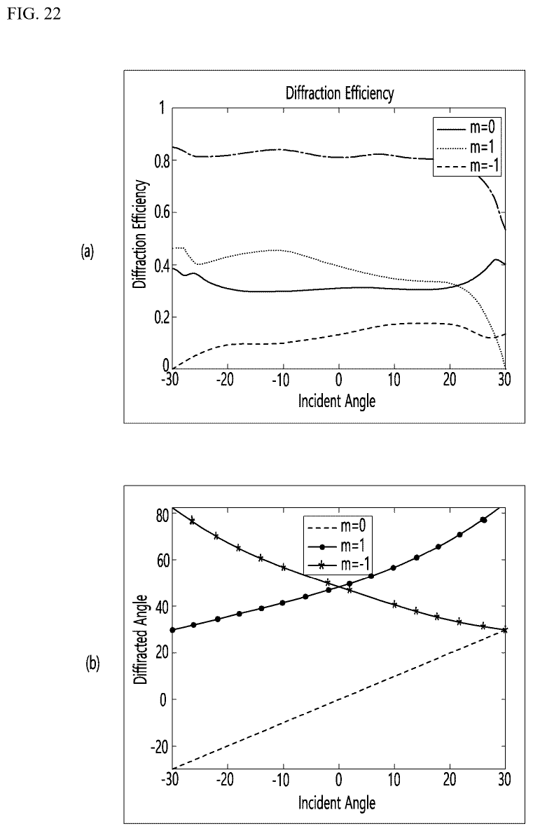

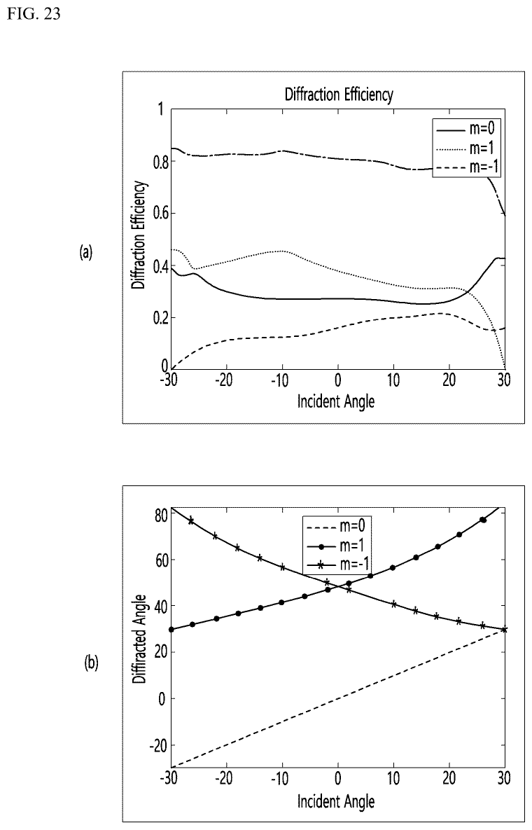

Hereinafter, the structure of the second light guide will be described with reference to FIGS. 14 to 23.

Referring to FIGS. 14 to 18, the second light guide 1200 may include a second structure 220.

FIGS. 14 to 18 are top views of the second light guide 1200. Referring to FIGS. 14 to 18, the second light guide 1200 may include a second substrate 120 and a second structure 220.

The second structure 220 may diffract light in a wavelength band of a set range. Specifically, the second structure 220 may selectively diffract light in at least one wavelength band among blue light and green light. That is, the second structure 220 may selectively diffract light in a second wavelength band of blue light. Alternatively, the second structure 220 may selectively diffract light in a third wavelength band of green light. Alternatively, the second structure 220 may selectively diffract light in the second wavelength band of blue light or light in the third wavelength band of green light.

Hereinafter, for convenience of explanation, it will be described focusing on the case where the second structure 220 selectively diffracts light in the second wavelength band of blue light.

The second substrate 120 may include a first transmission region T and a second transmission region NT by the second structure 220. Specifically, the second substrate 120 may include a first transmission region T where the second structure 220 is not arranged and a second transmission region NT where the second structure 220 is arranged. In the transmission region T, light (ray) may be transmitted and diffracted at an angle of a set range. Light passing through the second light guide 1200 may be diffracted by the first transmission region T and the second transmission region NT. Specifically, a phase difference occurs between the light passing through the first transmission region T and the light passing through the second transmission region NT. In addition, the sum of the phase differences may appear as a diffraction phenomenon.

The second structure 220 may include a plurality of patterns. For example, the second structure 220 may include a 2-1 pattern P2-1 and a 2-2 pattern P2-2. The 2-1 pattern P2-1 and the 2-2 pattern P2-2 may be extended in the second direction 2D. That is, the 2-1 pattern P2-1 and the 2-2 pattern P2-2 may have a width in the first direction 1D and a length in the second direction 2D. In addition, the 2-1 pattern P2-1 and the 2-2 pattern P2-2 may be spaced apart from each other. Specifically, the 2-1 pattern P2-1 and the 2-2 pattern P2-2 may be spaced apart in the first direction 1D.

The second structure 220 may include a plurality of unit structures. For example, the second structure 220 may include a plurality of second unit structures UN2. When the second substrate 120 is divided into a plurality of unit areas, a structure in which structure shapes of the same shape are arranged in a plurality of unit areas may be defined as the second unit structure UN2.

Accordingly, the second unit structures UN2 adjacent in the first direction 1D may include the second structures 220 of the same shape. For example, one of the second unit structures UN2 adjacent in the first direction 1D may be the 2-1 pattern P2-1. In addition, another second unit structure may be the 2-2 pattern P2-2.

In addition, the second unit structures UN2 adjacent in the second direction 2D may include the second structures 220 of the same shape. For example, all the second unit structures UN2 adjacent in the second direction 2D may be the 2-1 pattern P2-1 or the 2-2 pattern P2-2.

In addition, the second unit structures UN2 adjacent in a diagonal direction of the first direction 1D and the second direction 2D may include the second structures 220 of the same shape. For example, any one second unit structure among the second unit structures UN2 adjacent in a diagonal direction may be the 2-1 pattern P2-1. In addition, another second unit structure may be the 2-2 pattern P2-2.

That is, the second light guide may be an aggregate of a plurality of second unit structures UN2.

The second unit structure UN2 may include structures symmetrical to each other. For example, the second structure 220 of the second unit structure UN2 may be symmetrical in the second direction 2D. That is, the second structure 220 of the second unit structure UN2 may be symmetrical in the second direction 2D with respect to the first direction 1D.

Accordingly, the first transmission region T and the second transmission region NT of the second unit structure UN2 may be symmetrical in the second direction 2D.

However, the embodiment is not limited thereto, and the second structure 220 of the second unit structure UN2 may be symmetrical in the first direction 1D. That is, the second structure 220 of the second unit structure UN2 may be symmetrical in the first direction 1D with respect to the second direction 2D.

Alternatively, the second structure 220 of the second unit structure UN2 may be symmetrical in the diagonal direction of the first direction 1D and the second direction 2D.

Hereinafter, for convenience of explanation, it will be described focusing on the case where the second structure 220 of the second unit structure UN2 is symmetrical in the second direction 2D with respect to the first direction 1D.

The second structure 210 may have a thickness of a set range. Specifically, the second structure 220 may be related to the wavelength size of light reacting with the second structure 220.

The thickness of the second structure 220 may be smaller than the wavelength of light reacting with the second structure. Specifically, the thickness of the second structure 220 may satisfy equation 4 shown below.

Second wavelength*0.25≤Thickness of second structure<Second wavelength*0.5 [Equation 4]

(Here, the second wavelength is 600 nm to 700 nm)

When the thickness of the second structure 220 satisfies equation 4, the interaction between the light (ray) entering at a set angle and the second structure increases. Accordingly, the diffraction efficiency can be improved.

However, when the thickness of the second structure 220 is smaller than 0.25 of the second wavelength, the interaction between the light (ray) entering at a set angle and the second structure decreases. Accordingly, the diffraction efficiency may be lowered. In addition, when the thickness of the second structure 220 is more than 0.5 of the second wavelength, the change in diffraction efficiency of the light (ray) entering at different angles may increase. Accordingly, the diffraction efficiency in a range of wide incident angle may be low. Or, the diffraction efficiency in a range of wide incident angle may be non-uniform.

The second unit structure UN2 may have a size of a set range. Specifically, the second unit structure UN2 has a length in the first direction L2-1 and a length in the second direction L2-2. The length in the first direction L2-1 and the length in the second direction L2-2 may have a set range.

The length in the first direction L2-1 and the length in the second direction L2-2 may be the same. That is, the second unit structure UN2 may be formed in a square shape.

Alternatively, the length in the first direction L2-1 and the length in the second direction L2-2 may be different. For example, the length in the first direction L2-1 may be greater than the length in the second direction L2-2. Alternatively, the length in the first direction L2-1 may be smaller than the length in the second direction L2-2. That is, the second unit structure UN2 may be formed in a rectangular shape.

The length in the first direction L2-1 and the length in the second direction L2-2 may be related to the wavelength size of light reacting with the second structure 220.

At least one length among the length in the first direction L2-1 and the length in the second direction L2-2 may be smaller than the wavelength of light reacting with the second structure. Specifically, the length in the first direction L2-1 and the length in the second direction L2-2 may satisfy equation 5 shown below.

Second wavelength*0.5≤Length in the first direction L2-1<Second wavelength*0.75, or

Second wavelength*0.5≤Length in the second direction L2-2<Second wavelength*0.75, or

Second wavelength*0.5≤Length in the first and second directions L2-1 and L2-2<Second wavelength*0.75. [Equation 5]

(Here, the second wavelength is 600 nm to 700 nm)

As the length in the first direction L2-1 and the length in the second direction L2-2 satisfy equation 5, the interaction between the light (ray) entering at a set angle and the second structure increases. Accordingly, the diffraction efficiency can be improved.

However, when the length in the first direction L2-1 and the length in the second direction L2-2 do not satisfy equation 5, the interaction between the light (ray) entering at a set angle and the second structure decreases. Accordingly, the diffraction efficiency may be lowered.

Alternatively, the length in the first direction L2-1 and the length in the second direction L2-2 may be related to the thickness of the second structure 220.

At least one length among the length in the first direction L2-1 and the length in the second direction L2-2 may be greater than the thickness of the second structure 220. Specifically, the length in the first direction L2-1 and the length in the second direction L2-2 may satisfy equation 6 shown below.

Length in the first direction L2-1*0.5≤Thickness of second structure≤Length in the first direction L2-1*0.75, or

Length in the second direction L2-2*0.5≤Thickness of second structure≤Length in the second direction L2-2*0.75, or

Length in the first and second directions L2-1 and L2-2*0.5≤Thickness of second structure≤Length in the first and second directions L2-1 and L2-2*0.75 [Equation 6]

As the thickness of the second structure satisfies equation 6, the interaction between the light (ray) entering at a set angle and the second structure increases. Accordingly, the diffraction efficiency can be improved.

However, when the thickness of the second structure does not satisfy equation 6, the interaction of the light (ray) entering at a set angle with the second structure decreases. Accordingly, the diffraction efficiency may be lowered.

The second unit structure UN2 may include a second protrusion unit P2. The second protrusion unit P2 may protrude in one direction. Specifically, the second protrusion unit P2 may protrude in the first direction D1. The second protrusion unit P2 may include a curved surface. The width of the second protrusion unit P2 may be narrowed while being extended in the protruding direction. Accordingly, the width of the second structure 220 of the second unit structure UN2 may decrease while being extended in the direction of the second protrusion unit P2.

In addition, the second protrusion unit P2 may be symmetrical in the second direction D2. That is, the second protrusion unit P2 may be symmetrical in the second direction D2 with respect to the line of the first direction passing through the center of the second unit structure UN2. That is, the second protrusion unit P2 may be symmetrical in the second direction 2D while protruding in the first direction D1.

The second structure 220 of the second unit structure UN2 may be arranged to have an area of a set range. For example, the area of the second structure 220 may be 50% or more of the total area of the second unit structure UN2. Specifically, the area of the second structure 212 may be 55% or more of the total area of the second unit structure UN2. More specifically, the area of the second structure 220 may be 60% or more of the total area of the second unit structure UN2.

In addition, the second structure 220 of the second unit structure UN2 may have a maximum pattern line of a set range. The maximum pattern line of the second structure 220 may be defined as a line having the largest number of pixels among the lines of the first direction 1D when the second unit structure UN1 is divided into a plurality of pixels.

The maximum pattern line of the second structure 220 may be 30 pixels or more. Specifically, the maximum pattern line of the second structure 220 may be 35 pixels or more. Specifically, the maximum pattern line of the second structure 220 may be 40 pixels or more.

In addition, the second structure 220 of the second unit structure UN2 may have a maximum pattern ratio of a set range. The maximum pattern ratio of the second structure 220 may be defined as a ratio of the length of the maximum pattern line to the total length of the line having the maximum pattern line.

The maximum pattern ratio of the second structure 210 may be 70% or higher. Specifically, the maximum pattern ratio of the second structure 210 may be 75% or higher. In more detail, the maximum pattern ratio of the second structure 220 may be 80% or higher. In more detail, the maximum pattern ratio of the second structure 220 may be 85% or higher.

As the second structure 220 satisfies the ranges of the area, maximum pattern line, and maximum pattern ratio, the interaction between the light (ray) entering at a set angle and the second structure increases. Accordingly, the diffraction efficiency can be improved.

However, when the second structure 220 does not satisfy the ranges of the area, maximum pattern line, and maximum pattern ratio, the interaction between the light (ray) entering at a set angle and the second structure decreases. Accordingly, the diffraction efficiency may be lowered.

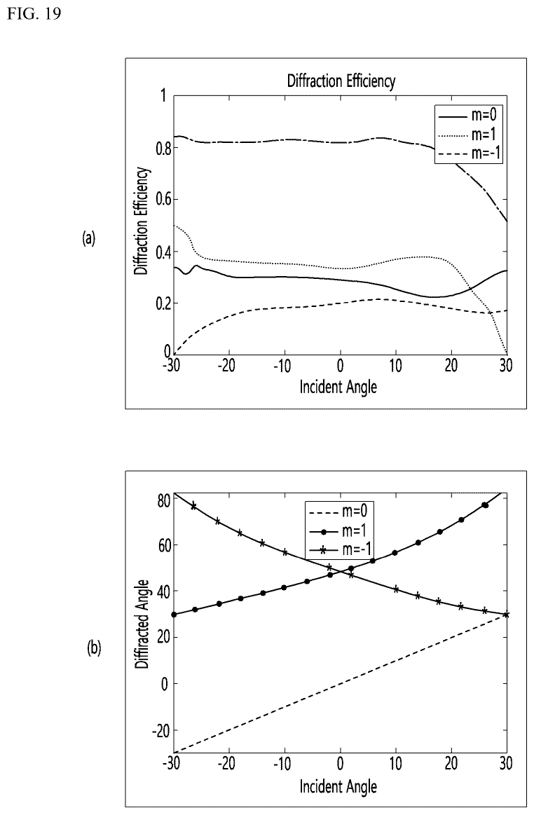

FIGS. 19 to 23 are views for explaining diffraction efficiency of the second light guide having the second unit structure of FIGS. 14 to 18, respectively.

FIGS. 19 to 23 (a) are graphs showing diffraction efficiency according to the incident angle. m=0 means light transmitted (refracted) without diffraction. m=1 means diffracted light. m=−1 means light that may generate various side effects due to the environment although diffraction is not targeted.

FIGS. 19 to 23 (b) are graphs showing diffraction angles according to the incident angle. m=−1 means an angle at which-1st-order diffracted light travels. m=0 means an angle at which 0th-order diffracted light travels. m=1 means an angle at which 1st-order diffracted light travels.

Referring to FIGS. 19 to 23, it can be seen that the diffracted m=1 curve has a uniform and high diffraction efficiency in a range of −23° to 23°.

In addition, lines other than m=−1, m=0, and m=1 mean a sum of diffraction efficiencies of the-1st, 0th, and 1st orders. In other words, it means that there are efficiencies of higher-order terms other than the-1st, 0th, and 1st orders. Referring to FIGS. 19 to 23, it can be seen that there is an efficiency of higher-order terms of about 20% or less in a range of −23° to 23°.

That is, it can be seen that the second light guide including the second structure according to an embodiment has uniform and high diffraction efficiency in a bandwidth range of wide incidence angle.

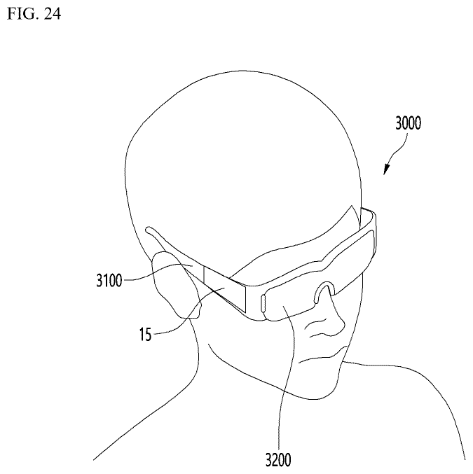

Hereinafter, an example of a display device including the light guide member 1000 according to an embodiment will be described with reference to FIG. 24.

Referring to FIG. 24, the light guide member 1000 according to an embodiment may be applied to a wearable display device. Specifically, the light guide member 1000 may be applied to a wearable display device worn on the head or an ear of a human body.

For example, the display device 3000 may be an augmented reality device.

The display device 3000 may include a wearing unit 3100, an optical member 15, and a display unit 3200.

The light guide member 1000 according to an embodiment may be adjacent to the optical member 15 including a light source. That is, the light guide member 1000 may be a wave guide adjacent to the optical member 15.

Alternatively, the light guide member 1000 according to an embodiment may be adjacent to the display unit 3200. Specifically, the light guide member 1000 according to an embodiment may be the display unit 3200. More specifically, the light guide member 1000 according to an embodiment may be AR glasses on which a display is shown.

The wearing unit 3100 may be extended in one direction. The wearing unit 3100 may be worn on the body of a user. For example, the wearing unit 3100 is worn on the head or an ear of a user. Accordingly, the display device 3000 may be fixed to the body of a user.

The optical member 15 may be connected to the wearing unit 3100. The optical member 10 may be adjacent to the display unit 3200. The optical member 15 may transfer light with a scanned image in the direction of the display unit 3200. The light passing through the display unit 3200 may be transferred to the eyes of a user.

Accordingly, the user may perceive augmented reality including virtual reality and actual reality through the optical member.

The features, structures, effects, and the like described above in the embodiments are included in at least one embodiment of the present invention, and are not necessarily limited to only one embodiment. Furthermore, the features, structures, effects, and the like exemplified in each embodiment may also be combined or modified and implemented in other embodiments by those skilled in the art. Therefore, the contents related to such combinations and modifications should be interpreted as being included in the scope of the present invention.

In addition, although it has been described above focusing on the embodiments, these are only examples and do not limit the present invention. Those skilled in the art will appreciate that various modifications and applications not exemplified above are possible without departing from the essential characteristics of the present embodiment. For example, each component specifically shown in the embodiments can be modified to be embodied. In addition, differences related to such modifications and applications should be interpreted as being included in the scope of the present invention defined in the appended claims.

1. A light guide member comprising:
at least one light guide among a first light guide, a second light guide, and a third light guide, wherein
each of the first light guide, the second light guide, and the third light guide includes a structure that reacts to light of a different wavelength range,
the first light guide includes a first substrate and a first structure arranged on the first substrate to react to light of a first wavelength range,
the first wavelength is 380 nm to 500 nm,
the first structure is formed as an aggregate of a plurality of first unit structures,
a structure of the first unit structures includes a first protrusion,
the first protrusion protrudes in a first direction, and
the first protrusion is symmetrical in a second direction with respect to a line of a first direction passing through a center of the first unit structure.

2. The light guide member according to claim 1, wherein the structure of the first unit structure is symmetrical in the second direction.

3. The light guide member according to claim 1, wherein a thickness of the first structure satisfies equation 1,
First wavelength*0.25≤Thickness of first structure<First wavelength*0.75. [Equation 1]

4. The light guide member according to claim 1, wherein a length in the first direction and a length in the second direction of the first structure satisfy equation 2,
First wavelength*0.5≤Length in the first direction<First wavelength*0.75, or
First wavelength*0.5≤Length in the second direction<First wavelength*0.75, or
First wavelength*0.5≤Length in the first and second directions<first wavelength*0.75. [Equation 2]

5. The light guide member according to claim 1, wherein a length in the first direction and a length in the second direction of the first structure satisfy equation 3,
Length in the first direction*0.25≤Thickness of first structure≤Length in the first direction*0.75, or
Length in the second direction*0.25≤Thickness of first structure≤Length in the second direction*0.75, or
Length in the first and second directions*0.25≤Thickness of first structure≤Length in the first and second directions*0.75. [Equation 3]

6. The light guide member according to claim 1, wherein the first structure includes a 1-1 pattern and a 1-2 pattern spaced apart from each other in the first direction, wherein the 1-1 pattern and the 1-2 pattern have a width in the first direction and a length in the second direction, and any one first unit structure among first unit structures adjacent in the first direction is the 1-1 pattern, and another first unit structure is the 1-2 pattern.

7. The light guide member according to claim 1, wherein the first structure of the first unit structure has a maximum pattern ratio of 70% or higher, and the maximum pattern ratio is defined as a ratio of a length of a maximum pattern line to a total length of a line having the maximum pattern line.

8. The light guide member according to claim 1, wherein
the second light guide includes a second substrate and a second structure arranged on the second substrate to react to light of a second wavelength range,
the second wavelength is 600 nm to 700 nm,
the second structure is formed as an aggregate of a plurality of second unit structures,
a structure of the second unit structures includes a second protrusion,
the second protrusion protrudes in the first direction, and
the second protrusion is symmetrical in the second direction with respect to a line of a first direction passing through a center of the second unit structure.

9. The light guide member according to claim 8, wherein a thickness of the second structure satisfies equation 4,
Second wavelength*0.25≤Thickness of second structure<Second wavelength*0.5. [Equation 4]

10. The light guide member according to claim 8, wherein a length in the first direction and a length in the second direction of the second structure satisfy equation 5,
Second wavelength*0.5≤Length in the first direction<Second wavelength*0.75, or
Second wavelength*0.5≤Length in the second direction<Second wavelength*0.75, or
Second wavelength*0.5≤Length in the first and second directions<Second wavelength*0.75. [Equation 5]

11. The light guide member according to claim 1, wherein a length in the first direction and a length in the second direction of the first unit structure are the same.

12. The light guide member according to claim 1, wherein a length in the first direction and a length in the second direction of the first unit structure are different.

13. The light guide member according to claim 1, wherein the first structure includes a 1-1 pattern and a 1-2 pattern spaced apart from each other in the first direction, wherein the 1-1 pattern and the 1-2 pattern have a width in the first direction and a length in the second direction, and the first unit structures adjacent in the first direction are the 1-1 pattern or the 1-2 pattern.

14. The light guide member according to claim 1, wherein an area of the first structure is 50% or more of the total area of the first unit structure.

15. The light guide member according to claim 8, wherein the second structure of the second unit structure is symmetrical in the second direction.

16. The light guide member according to claim 8, wherein a length in the first direction and a length in the second direction of the second unit structure are the same.

17. The light guide member according to claim 8, wherein a length in the first direction and a length in the second direction of the second unit structure are different.

18. The light guide member according to claim 16, wherein a length in the first direction and a length in the second direction of the second structure satisfy equation 6,
Length in the first direction*0.5≤Thickness of second structure<Length in the first direction*0.75, or
Length in the second direction*0.5≤Thickness of second structure<Length in the second direction*0.75, or
Length in the first and second directions*0.5≤Thickness of second structure<Length in the first and second directions*0.75. [Equation 6]

19. The light guide member according to claim 8, wherein the second structure includes a 2-1 pattern and a 2-2 pattern spaced apart from each other in the first direction, wherein the 2-1 pattern and the 2-2 pattern have a width in the first direction and a length in the second direction, and any one second unit structure among second unit structures adjacent in the first direction is the 2-1 pattern, and another second unit structure is the 2-2 pattern.

20. The light guide member according to claim 8, wherein the second structure includes a 2-1 pattern and a 2-2 pattern spaced apart from each other in the first direction, wherein the 2-1 pattern and the 2-2 pattern have a width in the first direction and a length in the second direction, and the second unit structures adjacent in the first direction is the 2-1 pattern or the 2-2 pattern.

21. The light guide member according to claim 17, wherein a length in the first direction and a length in the second direction of the second structure satisfy equation 6,
Length in the first direction*0.5≤Thickness of second structure<Length in the first direction*0.75, or
Length in the second direction*0.5≤Thickness of second structure<Length in the second direction*0.75, or
Length in the first and second directions*0.5≤Thickness of second structure<Length in the first and second directions*0.75. [Equation 6]
